(19) United States
(12) Patent Application Publication
(10) Pub. No.: US 2014/0060279 A1
(43) Pub. Date: Mar. 6, 2014

(54) Power Tool System

(71) Applicant: Rudolf Fuchs, Neuhausen (DE)

(72) Inventor: Rudolf Fuchs, Neuhausen (DE)

(73) Assignee: Robert Bosch GmbH, Stuttgart (DE)

(21) Appl. No.: 14/001,945

(22) PCT Filed: Mar. 2, 2012
(86) PCT No.: PCT/EP2012/000955

§ 371 Date: Nov. 9, 2013

(30) Foreign Application Priority Data
Mar. 3, 2011 (DE) 10 2011 005 020.5

(51) Int. Cl. B23D 57/02; B28D 1/08; B27B 17/02

(52) U.S. Cl. CPC B23D 57/02; B27B 17/02; B28D 1/08
USPC 83/794; 83/788; 83/820

(57) ABSTRACT

A power tool system includes at least one power tool which has at least one tool support unit for supporting a tool during machining, and at least one power tool separation device which extends through the tool support unit in at least one operational state. The disclosed power tool separation device comprises at least one cutting unit and at least one guide unit for guiding the cutting unit.

### PRIOR ART

Power tool systems which include a power tool and a power tool separating device are already known. The power tool, in this connection, has a workpiece support unit for supporting a workpiece during processing, through which the power tool separating device extends in at least one operating state.

### DISCLOSURE OF THE INVENTION

The invention proceeds from a power tool system having at least one power tool which includes at least one workpiece support unit for supporting a workpiece during processing, and having at least one power tool separating device which extends through the tool support unit in at least one operating state.

It is proposed that the power tool separating device has at least one cutting strand and at least one guide unit for guiding the cutting strand. In a particularly preferred manner, the power tool is realized as a bench saw, an under floor saw and/or as an under floor miter saw. However, it is also conceivable for the power tool to have another development which appears sensible to an expert. The weight of the power tool is in particular less than 60 kg, in a preferred manner less than 40 kg and in a particular preferred manner less than 30 kg. The power tool is preferably realized as a stationary power tool which is able to be transported by an operator without transporting machines. A “workpiece support unit”, is to be understood, in particular in this case, as a unit which is provided for the purpose of receiving a workpiece for processing when the power tool is being handled in the intended manner and which has at least one stop element, in particular a stop rail on which the workpiece is able to be placed for obtaining a precise cut during processing. In particular, a workpiece is placed and/or clamped onto the workpiece support unit for processing by the power tool. In a particularly preferred manner, the workpiece support unit is formed by a power tool bench, in particular by a power tool bench plate. In this connection, the workpiece support unit is formed, in particular, from aluminum. However, it is also conceivable for the workpiece support unit to be realized from another material which appears sensible to an expert. The term “extend through” is to define, in particular in this case, an arrangement of a component in relation to a further component, the component being arranged in a recess of the further component in at least one operating state and extending beyond an edge region of the further component defining the recess in at least one operating state.

A “cutting strand” is to be understood, in this case in particular, as a unit which is provided for the purpose of locally removing an atomic cohesion of a workpiece to be processed, in particular by means of mechanical separation and/or by means of mechanical removal of particles of the material of the workpiece. The term “provided for the purpose of” is to be understood, in this case in particular, as specially designed and/or specially equipped. In a preferred manner, the cutting strand is provided for the purpose of separating the workpiece into at least two parts which are physically separated from one another and/or for separating off and/or removing at least in part particles of the material of the workpiece proceeding from a surface of the workpiece. In a particularly preferred manner, the cutting strand is moved in a circulating manner in at least one operating state, in particular along a periphery of the guide unit. A “guide unit” is to be understood, in this case in particular, as a unit which is provided for the purpose of exerting a positive force onto the cutting strand at least along a direction at right angles to a cutting direction of the cutting strand in order to provide the cutting strand with a possibility of movement along the cutting direction. In a preferred manner, the guide unit has at least one guide element, in particular a guide groove, through which the cutting strand is guided. In a preferred manner, the cutting strand, when viewed in a cutting plane, is guided along an entire periphery of the guide unit by the guide unit by means of the guide element, in particular the guide groove. The guide unit is preferably realized as a sword. The term “sword” is to define, in this case in particular, a geometric form which, when viewed in the cutting plane, has an outside contour which is closed per se and includes at least two straight lines which extend parallel to one another and at least two connecting portions, in particular arcs of a circle, which in each case connect facing ends of the straight lines to one another. Consequently, the guide unit has a geometric form which, when viewed in the cutting plane, is made up from a rectangle and at least two circle sectors arranged at opposite ends of the rectangle.

The term “cutting plane” is to define, in this case in particular, a plane in which the cutting strand is moved in relation to the guide unit in at least one operating state along a periphery of the guide unit in at least two cutting directions which are directed in opposite directions to one another. In a preferred manner, when a workpiece is being processed, the cutting plane is aligned at least substantially transversely to a workpiece surface being processed. The term “at least substantially transversely” is to be understood, in this case in particular, as an alignment of a plane and/or of a direction in relation to a further plane and/or to a further direction which in a preferred manner deviates from a parallel alignment of the plane and/or of the direction in relation to the further plane and/or the further direction. However, it is also conceivable for the cutting plane, when a workpiece is being processed, to be aligned at least substantially parallel to a workpiece being processed, in particular when the cutting strand is realized as grinding means etc.

The term “at least substantially parallel” is to be understood, in this case in particular, as an alignment of a direction in relation to a reference direction, in particular in one plane, the direction having a deviation compared to the reference direction in particular of less than 8°, in an advantageous manner less than 5° and in a particularly advantageous manner less than 2°. A “cutting direction” is to be understood, in this case in particular, as a direction along which the cutting strand is moved for generating a clearance and/or for separating and/or for removing particles of material of a workpiece to be processed in at least one operating state as a result of a drive force and/or a drive moment, in particular in the guide unit. In a preferred manner, in an operating state the cutting strand is moved in relation to the guide unit along the cutting direction. The cutting strand and the guide unit preferably together form a closed system. The term “closed system” is to define, in this case in particular, a system which includes at least two components which, by means of interaction when the system is removed from a system which ranks higher than the system, such as, for example, a power tool, maintain a functionality and/or are connected captively to one another in the removed state. In a preferred manner, the at least two components of the closed system are connected together for a user in an at least substantially non-releasable manner. The term “at least substantially non-releasable” is to be understood, in this case in particular, as a connection between at least two components which are only separable from one another with the aid of separating tools, such as, for example, a saw, in particular a mechanical saw etc., and/or chemical parting agents, such as, for example, solvents etc. A compact power tool system can be achieved in an advantageous manner by means of the development as claimed in the invention.

In addition, it is proposed that, when mounted, the power tool separating device is mounted so as to be movable at least in relation to the workpiece support unit. The term “mounted so as to be movable” is to define, in particular in this case, a bearing arrangement of the power tool separating device, in particular of the guide unit together with the cutting strand, when mounted on and/or in the power tool, the power tool separating device, in particular uncoupled from elastic deforming of the power tool separating device, having a possibility of movement along at least one section greater than 10 mm, in a preferred manner greater than 20 mm and in a particularly preferred manner greater than 50 mm and/or a possibility of movement about at least one axis by an angle greater than 15°, in a preferred manner greater than 30° and in a particularly preferred manner greater than 40°. In a particularly preferred manner, the guide unit, together with the cutting strand arranged on the guide unit, is mounted so as to be movable at least in relation to the workpiece support unit when mounted. In particular, as a result of the movable bearing arrangement, the power tool separating device is adjustable in a stepless manner with respect to the workpiece support unit. In an advantageous manner, it is possible to adapt a position of the power tool separating device to a dimension of a workpiece arranged on the workpiece support unit and/or to adapt a position of the power tool separating device to a type of cut and/or depth of cut desired by the operator.

In an advantageous manner, when mounted, the power tool separating device is mounted so as to be movable at least substantially at right angles to a support surface of the workpiece support unit. The term “substantially at right angles” is to define, in this case in particular, an alignment of a direction in relation to a reference direction, the direction and the reference direction, in particular when viewed in one plane, enclosing an angle of 90° and the angle having a maximum deviation of in particular less than 8°, in an advantageous manner less than 5° and in a particularly advantageous manner less than 2°. In a preferred manner, the power tool has an adjustment unit which includes, for example, a rack-and-pinion gearing unit, by means of which an adjustment of the power tool separating device at least substantially at right angles to a support surface of the workpiece support unit is able to be achieved. A depth of cut of a cut which can be applied into a workpiece by means of the power tool separating device is able to be adjusted in an advantageous manner by means of the development as claimed in the invention.

In addition, it is proposed that, when mounted, the power tool separating device is mounted so as to be movable at least substantially parallel to a support surface of the workpiece support unit. The power tool separating device, in this connection, extends in a preferred manner at least substantially at right angles to the support surface of the workpiece support unit through the workpiece support unit. In a particularly preferred manner, the workpiece support unit has a recess, in particular an elongated hole, inside which the power tool separating device, when mounted, is able to move as a result of the movable bearing arrangement. In an advantageous manner, the power tool separating device is able to move in relation to the workpiece support unit for producing a cut into a workpiece to be processed. In addition, the power tool separating device is able to be moved onto a workpiece by an operator, whilst the workpiece is fixed in relation to the workpiece support unit, in particular at least by means of a stop element of the workpiece support unit.

When mounted, the power tool separating device and the workpiece support unit are preferably mounted so as to be pivotable in relation to one another. In a particularly preferred manner, when mounted, the power tool separating device is mounted so as to be pivotable in relation to the workpiece support unit. In a preferred manner, a pivot axis of the power tool separating device extends at least substantially parallel to the support surface of the workpiece support unit. In a preferred manner, the power tool separating device, proceeding from a center position, is pivotable into two oppositely directed directions in each case by an angle greater than 15°, in a preferred manner greater than 30° and in a particularly preferred manner greater than 40°. In a favored development of the invention, when mounted, the power tool separating device is mounted so as to be pivotable by 45° into two oppositely directed directions at least in relation to the workpiece support unit, in each case proceeding from a center position. In a preferred manner, the cutting plane of the cutting strand is moved toward the support surface of the workpiece support unit during a pivoting movement of the power tool separating device, proceeding from a center position. A “center position” is to be understood, in this case in particular, as a position of the power tool separating device in which the cutting plane is aligned at least substantially at right angles to the support surface. In an alternative development, a pivot axis extends at least substantially at right angles to the support surface of the workpiece support unit. A high level of flexibility during processing of a workpiece can be achieved in an advantageous manner by means of the power tool separating device as claimed in the invention, in particular with reference to possibilities for adjusting a position of the power tool separating device for processing a workpiece.

Furthermore, it is proposed that the power tool includes at least one drive unit which, together with the power tool separating device, when mounted, is mounted so as to be pivotable at least in relation to the workpiece support unit. In a preferred manner, a pivot axis, about which the drive unit and the power tool separating device are together pivotably mounted, extends at least substantially parallel to a longitudinal axis of the power tool separating device. The term “drive unit” is to define, in particular in this case, a unit which is provided for the purpose of generating forces and/or torques for driving the power tool separating device. In a preferred manner, thermal energy, chemical energy and/or electric energy is converted into kinetic energy for generating forces and/or torques by means of the drive unit. In a particularly preferred manner, the drive unit includes at least one rotor which has at least one armature shaft and at least one stator. The drive unit is preferably realized as an electric motor unit. However, it is also conceivable for the drive unit to have another development which appears sensible to an expert. In addition to the pivotable bearing arrangement, the drive unit of the power tool, when mounted, is preferably mounted together with the power tool separating device so as to be displaceable at least substantially parallel to a support surface of the workpiece support unit. The term “longitudinal axis” is to define, in particular in this case, an axis along which the power tool separating device has a maximum dimension. In a preferred manner, the longitudinal axis extends at least substantially parallel to the two straight lines of the outside contour of the guide unit. In an advantageous manner, a mitered cut can be generated in a workpiece to be processed by means of the pivotable bearing arrangement of the drive unit and of the power tool separating device.

In addition, the invention proceeds from a power tool separating device for a power tool system as claimed in the invention. The power tool separating device includes at least one cutting strand and at least one guide unit. In an advantageous manner, an all-round tool for processing workpieces can be achieved.

In an advantageous manner, the power tool separating device includes a torque transmitting element which is mounted at least in part in the guide unit. In a preferred manner, the torque transmitting element is surrounded by outside walls of the guide unit at least in part along at least one direction. In a preferred manner, the torque transmitting element has a concentric coupling recess into which a pinion of the motor unit and/or a toothed wheel and/or a toothed shaft of the gearing unit is able to engage when mounted. In a preferred manner in this connection, the coupling recess is formed by a hexagon socket. However, it is also conceivable for the coupling recess to have another development which appears sensible to an expert. By means of the development of the power tool separating device as claimed in the invention, a closed system which is mountable in a convenient manner by an operator on a power tool provided for this purpose can be achieved in a structurally simple manner. Consequently, it is possible, in an advantageous manner, to dispense with individual mounting of components, such as, for example, the cutting strand, the guide unit and the torque transmitting element, by the operator for using the power tool separating device as claimed in the invention.

In addition, it is proposed that the cutting strand has at least one cutting edge carrying element which, on a side of the cutting edge carrying element facing the torque transmitting element, has at least one recess into which the torque transmitting element engages in at least one operating state for driving the cutting strand. In a preferred manner in this connection, the torque transmitting element is realized as a toothed wheel which has a plurality of teeth for driving the cutting strand along a circumferential direction which runs in a plane which extends at right angles to the axis of rotation. In a preferred manner, the recess of the cutting edge carrying element is realized in a corresponding manner to an outside contour of the teeth of the torque transmitting element which is realized as a toothed wheel. However, it is also conceivable for the torque transmitting element and/or the cutting edge carrying element to have another development which appears sensible to an expert. In a particularly preferred manner, the cutting edge carrying element is realized at least on the side facing the torque transmitting element at least substantially in a circular manner. The side of the cutting edge carrying element facing the torque transmitting element, when mounted, is realized in particular in at least one part region in a circular manner, when viewed between a center axis of the connecting element arranged in and/or on the cutting edge carrying element and a center axis of a connecting recess of the cutting edge carrying element for receiving the connecting element. In a preferred manner, the circular part region is realized adjoining the recess in which the torque transmitting element engages. In a particularly preferred manner, the circular part region has a radius which corresponds at least substantially to a radius of a guide contour of the guide unit, in particular of a guide contour of a guide element of the guide unit which is arranged on a convex end. The side of the cutting edge carrying element facing the torque transmitting element when mounted, in particular the part region, is preferably realized in a concave manner. It is possible to transmit forces and/or torques for driving the cutting strand from the torque transmitting element to the cutting edge carrying element in a structurally simple manner by means of the recesses of the cutting edge carrying element.

Furthermore, the invention proceeds from a power tool for a power tool system as claimed in the invention, having at least one workpiece support unit for supporting a workpiece during processing and having at least one coupling device for coupling with a power tool separating device as claimed in the invention. A “coupling device” is to be understood, in this case in particular, as a device which is provided for the purpose of connecting the power tool separating device in an operative manner to the portable power tool for processing a workpiece by means of a positive-locking and/or friction-locking connection. In particular, with the coupling device coupled with the power tool separating device and the portable power tool operating, forces and/or torques can be transmitted from the drive unit of the portable power tool to the power tool separating device for driving the cutting strand. Consequently, the coupling device is preferably realized as a tool holder.

The power tool separating device as claimed in the invention and/or the portable power tool as claimed in the invention are not to be restricted in this connection to the above-described application and embodiment. In particular, the power tool separating device as claimed in the invention and/or the portable power tool as claimed in the invention can have a number of individual elements, components and units which deviates from a number named herein for fulfilling a method of operation described herein.

### DRAWING

Further advantages are produced from the following description of the drawing. Exemplary embodiments of the invention are shown in the drawing. The drawing, the description and the claims include numerous features in combination. The expert will also consider the features individually in an expedient manner and combine them to form sensible further combinations.

The drawing, in which:

FIG. 1 shows a schematic representation of a power tool as claimed in the invention with a power tool separating device as claimed in the invention,

FIG. 2 shows a schematic representation of a view of a detail of the power tool separating device as claimed in the invention,

FIG. 3 shows a schematic representation of a sectioned view along the line III-III from FIG. 2 of the power tool separating device as claimed in the invention,

FIG. 4 shows a schematic representation of a view of a detail of cutting edge carrying elements of a cutting strand of the power tool separating device as claimed in the invention,

FIG. 5 shows a schematic representation of a view of a further detail of one of the cutting edge carrying elements of the cutting strand of the power tool separating device according to the invention,

FIG. 6 shows a schematic representation of a view of a detail of an arrangement of the cutting edge carrying elements in a guide unit of the power tool separating device as claimed in the invention,

FIG. 7 shows a schematic representation of an alternative power tool as claimed in the invention with a power tool separating device as claimed in the invention,

FIG. 8 shows a schematic representation of a further alternative power tool as claimed in the invention with a power tool separating device as claimed in the invention,

FIG. 9 shows a schematic representation of a further alternative power tool as claimed in the invention with a power tool separating device as claimed in the invention,

FIG. 10 shows a view of a detail of a bearing arrangement of a drive unit and of the power tool separating device as claimed in the invention in the alternative power tool as claimed in the invention from FIG. 9 and

FIG. 11 shows a schematic representation of a further alternative power tool as claimed in the invention with a power tool separating device as claimed in the invention.

### DESCRIPTION OF THE EXEMPLARY EMBODIMENTS

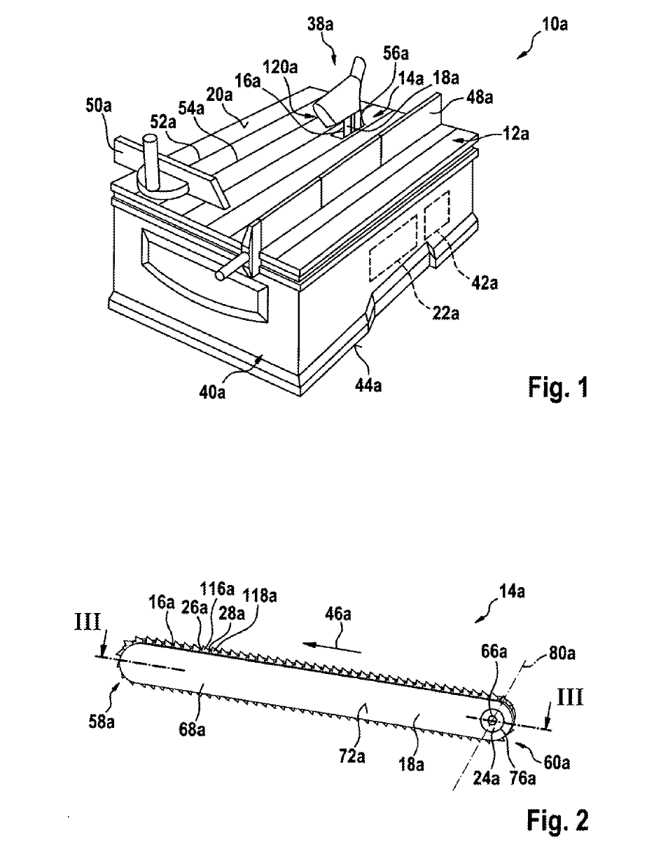

FIG. 1 shows a power tool system which includes a power tool 10a formed by a bench saw and a power tool separating device 14a. The power tool 10a includes a coupling device 38a which is realized as a tool holder for the positive-locking and/or friction-locking coupling of the power tool separating device 14a with the power tool 10a. The power tool separating device 14a includes a cutting strand 16a and a guide unit 18a for guiding the cutting strand 16a. The power tool 10a has a workpiece support unit 12a which is formed by a tool bench plate which is arranged on a basic body unit 40a of the power tool 10a. The basic body unit 40a is provided for the purpose of receiving and/or mounting a drive unit 22a, a gearing unit 42a and other components and/or units which appear sensible to an expert for operating a power tool 10a. With the power tool 10a being used in the manner intended, the power tool 10a is placed for processing workpieces (not shown here in any detail) by way of a bottom surface 44a of the basic body unit 40a onto a suitable surface, such as, for example, a work bench and/or a floor in a production hall, etc. However, it is also conceivable for the basic body unit 40a to have retractable feet by means of which the power tool 10a is able to be placed onto a suitable surface for processing workpieces. The workpiece support unit 12a is provided for supporting a workpiece during processing. In this connection, the workpiece support unit 12a has two stop elements 48a, 50a which are realized as adjustable stop rails on which a workpiece to be processed can be placed for guidance. The stop elements 48a, 50a are adjustable by means of guide grooves 52a, 54a of the workpiece support unit 12a and/or are mounted so as to be movable on a support surface 20a of the workpiece support unit 12a. One of the two stop elements 48a, 50a is provided for the purpose of providing, in a manner already known to an expert, a length of a part piece to be separated off by means of the power tool separating device 14a and/or a position of a cut to be inserted into the workpiece by means of the power tool separating device 14a in relation to an outside surface of the workpiece. In addition, one of the two stop elements 48a, 50a is provided for the purpose of guiding the workpiece when moving on the support surface 20a in the direction of the power tool separating device 14a. When a workpiece is being processed, the workpiece is moved by means of one of the stop elements 48a, 50a on the support surface 20a in the direction of the power tool separating device 14a.

The power tool separating device 14a extends in an operating state through the tool support unit 12a. In this connection, the tool support unit 12a, in the support surface 20a, has a recess 56a by means of which the power tool separating device 14a, when mounted, extends at least substantially at right angles to the support surface 20a through the tool support unit 12a. In addition, it is conceivable for the power tool 10a to include a protection device (not shown in any detail) which, by means of a sensor unit of the protection device, senses a position of a hand of an operator in relation to the power tool separating device 14a and which, in the event of a dangerous situation for the operator, actively brakes the cutting strand 16a of the power tool separating device 14a and/or interrupts an energy supply to the drive unit 22a.

The drive unit 22a and the gearing unit 42a are operatively connected together in a manner already known to an expert for generating a drive moment which is transmittable to the power tool separating device 14a. In this connection, the drive unit 22a and/or the gearing unit 42a are provided for the purpose of being coupled with the cutting strand 16a of the power tool separating device 14a by means of the coupling device 38a with the power tool separating device 14a mounted. The gearing unit 42a of the portable power tool 10a is realized as miter gearing. The drive unit 22a is realized as an electric motor unit. However, it is also conceivable for the drive unit 22a and/or the gearing unit 42a to have another development which appears sensible to an expert. In addition, it is also conceivable for the drive unit 22a, uncoupled from the gearing unit 42a, to be directly couplable with the power tool separating device 14a. The drive unit 22a is provided for the purpose of driving the cutting strand 16a of the power tool separating device 14a in at least one operating state at a cutting speed of less than 6 m/s. In this connection, the power tool 10a has at least one operating mode in which it is possible for the cutting strand 16a to be driven in the guide unit 18a of the power tool separating device 14a along a cutting direction 46a of the cutting strand 12 at a cutting speed of less than 6 m/s.

In addition, the power tool 10a has a safety hood 120a which surrounds the power tool separating device 14a in part at least when operating. The safety hood 120a includes two side walls, between which the power tool separating device 14a is arranged in at least one operating state. The side walls of the protective hood 120a extend, when mounted, at least substantially parallel to the cutting plane of the cutting strand 16a. The protective hood 120a can be pivoted in relation to the power tool separating device 14a for processing a workpiece. However, it is also conceivable for the protective hood 120a to have another development which appears sensible to an expert.

FIG. 2 shows the power tool separating device 14a when uncoupled from the coupling device 38a of the power tool 10a. The cutting strand 16a and the guide unit 18a together form a closed system. The guide unit 18a is realized as a sword. In addition, the guide unit 18a, when viewed in the cutting plane of the cutting strand 16a, has at least two convexly realized ends 58a, 60a. The convexly realized ends 58a, 60a of the guide unit 18a are arranged on two sides of the guide unit 18a remote from one another. The cutting strand 16a is guided by means of the guide unit 18a. To this end, the guide unit 18a has at least one guide element 62a (FIG. 6), by means of which the cutting strand 16a is guided. In this connection, the guide element 62a is realized as a guide groove 64a which extends in a cutting plane of the cutting strand 16a along an entire periphery of the guide unit 18a. In this connection, the cutting strand 16a is guided by means of edge regions of the guide unit 18a which define the guide groove 64a. However, it is also conceivable for the guide element 62a to be realized in another manner, such as, for example, rib-like molding on the guide unit 18a which engages in a recess on the cutting strand 16a. The cutting strand 16a, when viewed in a plane which extends at right angles to the cutting plane, is surrounded on three sides by the edge regions which define the guide groove 64a (FIG. 6). During operation, the cutting strand 16a is moved in relation to the guide unit 18a in a circulating manner along the periphery in the guide groove 64a.

In addition, the power tool separating device 14a has a torque transmitting element 24a, which is mounted at least in part by means of the guide unit 18a, for driving the cutting strand 16a. In this connection, the torque transmitting element 24a has a coupling recess 66a which, when mounted, is couplable with an output shaft (not shown here in any detail) of the gearing unit 42a and/or with a toothed wheel (not shown here in any detail) of the gearing unit 42a arranged on the output shaft. However, it is also conceivable for the torque transmitting element 24a, when coupled, for driving the cutting strand 16a, to be coupled directly with a pinion (not shown here in any detail) of the drive unit 22a which is arranged on a drive shaft (not shown here in any detail) of the drive unit 22a. The coupling recess 66a is arranged concentrically in the torque transmitting element 24a. The coupling recess 66a is realized as a hexagon socket. However, it is also conceivable for the coupling recess 66a to have another development which appears sensible to an expert.

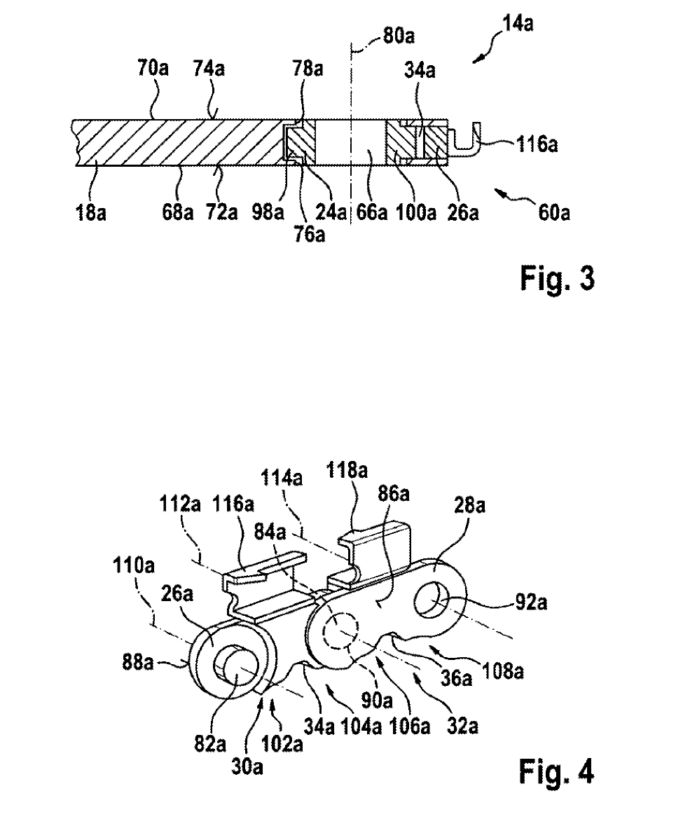

When uncoupled, the torque transmitting element 24a is arranged so as to be movable in the guide unit 18a transversely with respect to the cutting direction 46a of the cutting strand 16a and/or along the cutting direction 46a (FIG. 3).

In this connection, the torque transmitting element 24a is arranged at least in part between two outside walls 68a, 70a of the guide unit 18a. The outside walls 68a, 70a extend at least substantially parallel to the cutting plane of the cutting strand 16a. The guide unit 18a has in outside faces 72a, 74a of the outside walls 68a, 70a in each case a recess 76a, 78a in which the torque transmitting element 24a is arranged at least in part.

The torque transmitting element 24a is arranged with a part region in the recesses 76a, 78a of the outside walls 70a, 72a. In this connection, the torque transmitting element 24a, at least in the part region arranged in the recesses 76a, 78a, has an extension along an axis of rotation 80a of the torque transmitting element 24a which closes off in a flush manner with one of the outside faces 72a, 74a of the guide unit 18a. In addition, the part region of the torque transmitting element 24a arranged in the recesses 76a, 78a of the outside faces 72a, 74a of the guide unit 18a has an outside dimension which extends at least substantially at right angles to the axis of rotation 80a of the torque transmitting element 24a and is at least 0.1 mm smaller than an inside dimension of the recesses 76a, 78a which extends at least substantially at right angles to the axis of rotation 80a of the torque transmitting element 24a. The part region of the torque transmitting element 24a arranged in the recesses 76a, 78a is arranged along a direction which runs at right angles to the axis of rotation 80a in each case at a spacing to an edge of the outside walls 70a, 72a which defines the respective recess 76a, 78a. Consequently, the part region of the torque transmitting element 24a arranged in the recesses 76a, 78a has a clearance inside the recesses 76a, 78a.

FIG. 4 shows a view of a detail of cutting edge carrying elements 26a, 28a of the cutting strand 16a of the power tool separating device 14a. The cutting edge 16a includes a plurality of interconnected cutting edge carrying elements 26a, 28a which, in each case, are connected together by means of a connecting element 82a, 84a of the cutting strand 16a, said connecting element closing off in an at least substantially flush manner with one of two outside faces 86a, 88a of the interconnected cutting edge carrying elements 26a, 28a (cf. also FIG. 6). The connecting elements 82a, 84a are realized in a bolt-shaped manner. The outside faces 86a, 88a, with the cutting strand 16a arranged in the guide groove 64a, run at least substantially parallel to the cutting plane of the cutting strand 16a. An expert will select a number of cutting edge carrying elements 26a, 28a suitable for the cutting strand 16a in dependence on the application. The cutting edge carrying elements 26a, 28a are realized in each case integrally with one of the connecting elements 26a, 28a. In addition, the cutting edge carrying elements 26a, 28a each have a connecting recess 90a, 92a for receiving one of the connecting elements 82a, 84a of the interconnected cutting edge carrying elements 26a, 28a. The connecting elements 82a, 84a are guided by means of the guide unit 18a (FIG. 6). In this connection, the connecting elements 82a, 84a, with the cutting strand 16a mounted, are arranged in the guide groove 64a. The connecting elements 82a, 84a, when viewed in a plane extending at right angles to the cutting plane, can be supported on two side walls 94a, 96a of the guide groove 64a. The side walls 94a, 96a define the guide groove 64a along a direction which extends at right angles to the cutting plane. In addition, the side walls 94a, 96a of the guide groove 64a, when viewed in the cutting plane, proceeding from the guide unit 18a, extend outward at right angles to the cutting direction 46a of the cutting strand 16a.

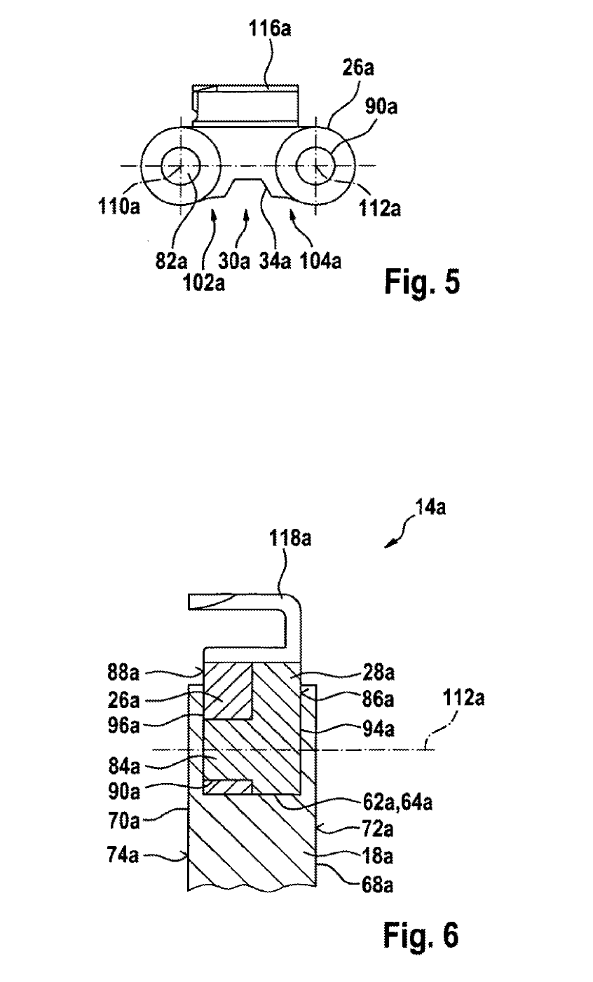

The cutting edge carrying elements 26a, 28a of the cutting strand 16a each have a recess 34a, 36a which in each case, in a mounted state, is arranged on a side 30a, 32a of the respective cutting edge carrying element 26a, 28a facing the torque transmitting element 24a. The torque transmitting element 24a engages in the recesses 34a, 36a in at least one operating state to drive the cutting strand 16a. The torque transmitting element 24a, in this connection, is realized as a toothed wheel. Consequently, the torque transmitting element 24a includes teeth 98a, 100a which are provided for the purpose of engaging in the recesses 34a, 36a of the cutting edge carrying elements 26a, 28a in at least one operating state to drive the cutting strand 16a. In addition, the sides 30a, 32a of the cutting edge carrying elements 26a, 28a facing the torque transmitting element 24a are realized in a circular manner. The sides 30a, 32a of the cutting edge carrying elements 26a, 28a facing the torque transmitting element 24a in a mounted state, when viewed between a center axis 110a of the respective connecting element 82a, 84a and a center axis 112a, 114a of the respective connecting recess 90a, 92a, are in each case realized in a circular manner in part regions 102a, 104a, 106a, 108a. The circular part regions 102a, 104a, 106a, 108a are in each case realized adjoining the recesses 34a, 36a into which the torque transmitting element 24a engages. In this connection, the circular part regions 102a, 104a, 106a, 108a have a radius which corresponds to a radius of a development of the guide groove 64a on the convex ends 58a, 60a. The part regions 102a, 104a, 106a, 108a are realized in a concave manner (FIG. 5).

In addition, the cutting strand 16a has cutting elements 116a, 118a. The cutting elements 116a, 118a are in each case realized integrally with one of the cutting edge carrying elements 26a, 28a. However, it is also conceivable for the cutting elements 116a, 118a to be realized separately from the cutting edge carrying elements 26a, 28a. A number of cutting elements 116a, 118a is dependent on a number of cutting edge carrying elements 26a, 28a. An expert will select a suitable number of cutting elements 116a, 118a in dependence on the number of cutting edge carrying elements 26a, 28a. The cutting elements 116a, 118a are provided for the purpose of making it possible to separate off and/or to remove particles of the material of a workpiece to be processed. The cutting elements 116a, 118a can be realized, for example, as full chisel tools, half chisel tools or other types of cutting edges which appear sensible to an expert and are provided for the purpose of making it possible to separate off and/or to remove particles of the material of a workpiece to be processed. The cutting strand 16a is realized in an endless manner. Consequently, the cutting strand 16a is realized as a cutting chain. In this connection, the cutting edge carrying elements 26a, 28a are realized as chain links which are connected together by means of the bolt-shaped connecting elements 82a, 84a. However, it is also conceivable for the cutting strand 16a, the cutting edge carrying elements 26a, 28a and/or the connecting elements 82a, 84a to be developed in another manner which appears sensible to an expert.

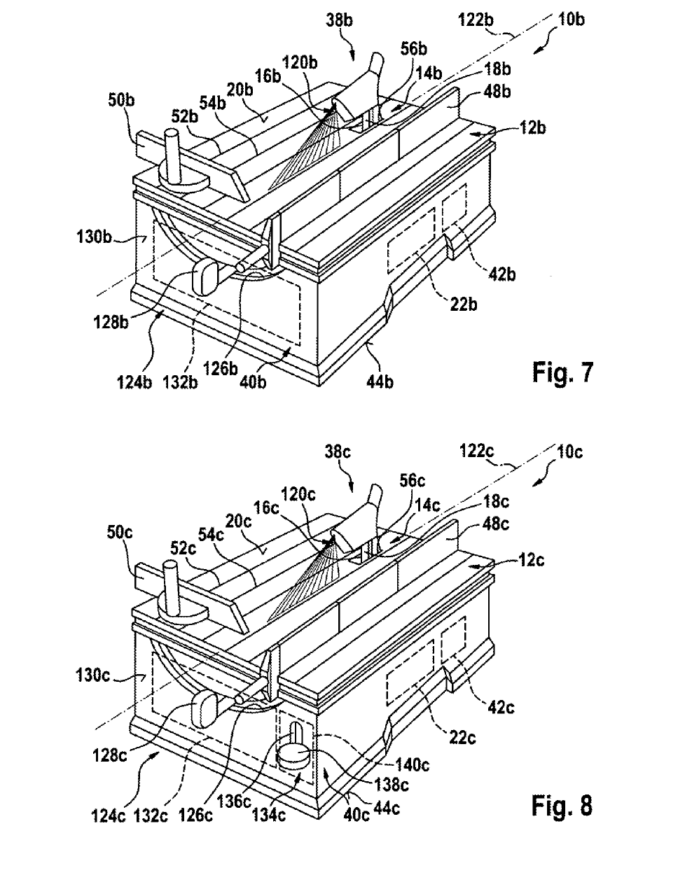

FIGS. 7 to 11 show alternative exemplary embodiments. Substantially identical components, features and functions are in principle numbered with the identical references. To differentiate between the exemplary embodiments, the letters a to e are added to the references of the exemplary embodiments. The following description is restricted essentially to the differences to the first exemplary embodiment in FIGS. 1 to 6, it being possible to refer to the description of the first exemplary embodiment in FIGS. 1 to 6 with reference to components, features and functions which remain the same.

FIG. 7 shows an alternative power tool system which includes a power tool 10b which is realized as a bench saw and a power tool separating device 14b. The power tool separating device 14b has a cutting strand 16b and a guide unit 18b for guiding the cutting strand 16b. In addition, the power tool separating device 14b is designed in an analogous manner to the power tool separating device 14a which has been described in FIGS. 1 to 6. The power tool 10b includes a workpiece support unit 12b for supporting a workpiece during processing by means of the power tool separating device 14b and a basic body unit 40b on which the workpiece support unit 12b is arranged. The workpiece support unit 12b, in a support surface 20b of the workpiece support unit 12b, has a recess 56b, by means of which the power tool separating device 14b extends in at least one operating state through the workpiece support unit 12b. The power tool separating device 14b, when mounted, is mounted so as to be movable in relation to the workpiece support unit 12b. The guide unit 18b, together with the cutting strand 16b mounted on the guide unit 18b, when mounted, is mounted so as to be movable in relation to the workpiece support unit 12b. In this connection, the power tool separating device 14b is mounted, when mounted, so as to be pivotable at least in relation to the workpiece support unit 12b. The guide unit 18b, together with the cutting strand 16b mounted on the guide unit 18b, when mounted, is mounted so as to be pivotable in relation to the workpiece support unit 12b.

A pivot axis 122b of the power tool separating device 14b extends at least substantially parallel to the support surface 20b of the workpiece support unit 12b. When the power tool separating device 14b pivots in relation to the workpiece support unit 12b, a cutting plane of the cutting strand 16b is tilted in relation to the support surface 20b of the workpiece support unit 14b. Proceeding from a center position of the power tool separating device 14b, the power tool separating device 14b can be pivoted into two oppositely directed directions in relation to the workpiece support unit 14b. In the center position of the power tool separating device 14b, the cutting plane of the cutting strand 16b extends at least substantially at right angles to the support surface 20b. Proceeding from the center position, the power tool separating device 14b can be pivoted in each case along the two oppositely directed directions by an angle of 45° about the pivot axis 122b.

The power tool 10b includes a pivot unit 124b by means of which an operator is able to pivot the power tool separating device 14b in relation to the workpiece support unit 12b. The pivot unit 124b includes a circular recess 126b in which a control element 128b is arranged so as to be movable. The recess 126b, in this connection, is arranged in a side face 130b of the basic body unit 40b. The control element 128b is operatively connected by means of a rod assembly (not shown here in any detail) to the power tool separating device 14b and/or to a drive unit 22b and to a gearing unit 42b of the power tool 10b. The basic body unit 40b additionally includes a circular connecting link (not shown here in any detail) for the bearing arrangement of the rod assembly in the basic body unit 40b. The connecting link is arranged on a side of the basic body unit 40b which lies opposite the side face 130b, in which the circular recess 126b is arranged, along a direction which extends at right angles to the side face 130b. The drive unit 22b and the gearing unit 42b are pivoted about the pivot axis 122b together with the power tool separating device 14b during a pivot movement. However, it is also conceivable for the control element 128b to be operatively connected to the power tool separating device 14b and/or to the drive unit 22b and to the gearing unit 42b of the power tool 10b by means of another element and/or mechanism which appears sensible to an expert.

In addition, the pivot unit 124b includes a latching device 132b which is provided for the purpose of fixing the rod assembly and consequently the power tool separating device 14b together with the drive unit 22b and the gearing unit 42b in a pivot position in relation to the support surface 20b. The pivot position, in this connection, can be adjusted in a stepless manner, such as, for example, by means of a clamping device which holds the rod assembly in a pivot position. However, it is also conceivable for the pivot position to be adjustable in steps, such as, for example, by means of latching recesses or latching projections of the latching device 132b into which the rod assembly can latch or which can latch in recesses in the rod assembly.

FIG. 8 shows a further alternative power tool system which includes a power tool 10c which is realized as a bench saw and a power tool separating device 14c. The power tool separating device 14c has a cutting strand 16c and a guide unit 18c for guiding the cutting strand 16c. In addition, the power tool separating device 14c is designed in an analogous manner to the power tool separating device 14a which has been described in FIGS. 1 to 6. The power tool 10c is designed in an at least substantially analogous manner to the power tool 10b described in FIG. 7. The power tool 10c includes a workpiece support unit 12c for supporting a workpiece during processing and a basic body unit 40c on which the workpiece support unit 12c is arranged. The workpiece support unit 12c, in a support surface 20c of the workpiece support unit 12c, has a recess 56c, by means of which the power tool separating device 14c extends in at least one operating state through the workpiece support unit 12c. The power tool separating device 14c, when mounted, is mounted so as to be movable in relation to the workpiece support unit 12c. In this connection, the guide unit 18c, together with the cutting strand 16c mounted on the guide unit 18c, when mounted, is mounted so as to be movable in relation to the workpiece support unit 12c. In addition, the power tool separating device 14c, when mounted, is mounted so as to be pivotable at least in relation to the workpiece support unit 12c. The guide unit 18c, together with the cutting strand 16c mounted on the guide unit 18c, when mounted, is mounted so as to be pivotable in relation to the workpiece support unit 12c. In this connection, the power tool 10c has a pivot unit 124c which includes a circular recess 126c and a control element 128c.

In addition, the power tool separating device 14c is mounted so as to be movable along a at least substantially at right angles to the support surface 20c. In this connection, the power tool 10c has a linear adjustment unit 134c which is provided for the purpose of moving the power tool separating device 14c in a linear manner along the direction extending at right angles to the support surface 20c. The linear adjustment unit 134c includes a recess 136c which is realized as an elongated hole and in which a further control element 138b is movably arranged. The recess 136c, in this connection, is arranged in a side face 130c of the basic body unit 40c. The control element 138c is operatively connected by means of a rod assembly (not shown here in any detail) to the power tool separating device 14c and/or to a drive unit 22c and to a gearing unit 42c of the power tool 10c. The basic body unit 40c additionally includes a connecting link (not shown here in any detail) for the bearing arrangement of the rod assembly in the basic body unit 40c. The connecting link is arranged on a side of the basic body unit 40c which lies opposite the side face 130c, in which the recess 136c realized as an elongated hole is arranged, along a direction extending at right angles to the side face 130c. The drive unit 22c and the gearing unit 42c are moved in the case of a linear movement together with the power tool separating device 14c in a linear manner along the direction extending at right angles to the support surface 20c. However, it is also conceivable for the further control element 138c to be connected operatively to the power tool separating device 14c and/or to the drive unit 22c and to the gearing unit 42c of the power tool 10c by means of another element and/or mechanism which appears sensible to an expert.

In addition, the linear adjustment unit 134c has a further latching device 140c which is provided for the purpose of fixing the rod assembly and consequently the power tool separating device 14c together with the drive unit 22c and the gearing unit 42c in a linear position in relation to the support surface 20c. The linear position, in this connection, can be steplessly adjustable, such as, for example, by means of a clamping device which holds the rod assembly in a linear position. However, it is also conceivable for the linear position to be adjustable in steps, such as, for example, by means of latching recesses or latching projections of the further latching device 140c into which the rod assembly is able to latch or which are able to latch in recesses in the rod assembly.

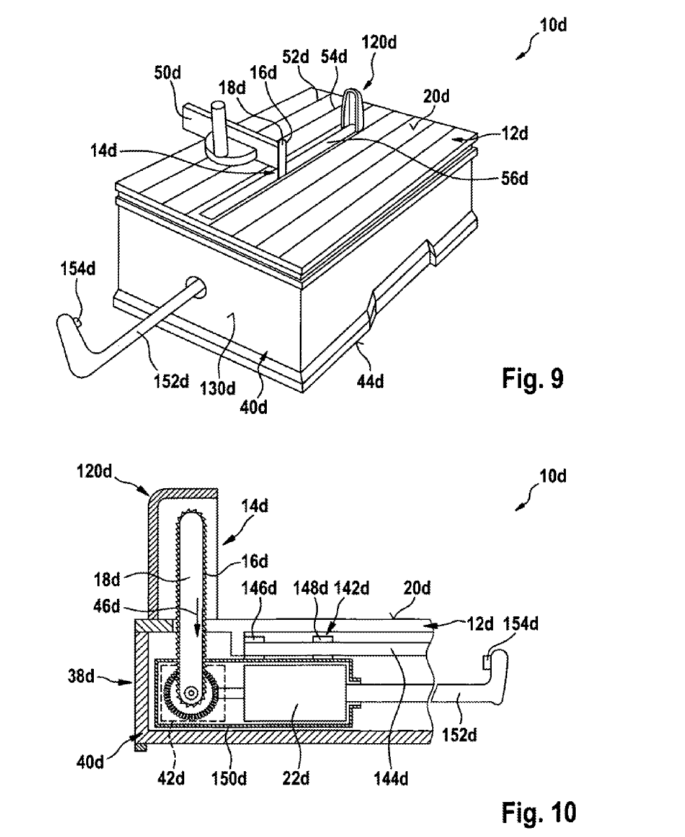

FIG. 9 shows a further alternative power tool system which includes a power tool 10d which is realized as an under floor saw and a power tool separating device 14d. The power tool separating device 14d has a cutting strand 16d and a guide unit 18d for guiding the cutting strand 16d. In addition, the power tool separating device 14d is designed in an analogous manner to the power tool separating device 14a which has been described in FIGS. 1 to 6. The power tool 10d includes a workpiece support unit 12d for supporting a workpiece during processing and a basic body unit 40d on which the workpiece support unit 12d is arranged. The workpiece support unit 12d, in a support surface 20d of the workpiece support unit 12d, has a recess 56d, by means of which the power tool separating device 14d extends in at least one operating state through the workpiece support unit 12d. The power tool separating device 14d, when mounted, is mounted so as to be movable in relation to the workpiece support unit 12d. In this connection, the guide unit 18d, together with the cutting strand 16d mounted on the guide unit 18d, when mounted, is mounted so as to be movable in relation to the workpiece support unit 12d. The power tool separating device 14d is mounted together with a drive unit 22d and a gearing unit 42d of the power tool 10d so as to be linearly movable along a direction extending at least substantially parallel to the support surface 20d in relation to the workpiece support unit 12d. In this connection, the power tool 10d has a linear bearing unit 142d which is provided for mounting the power tool separating device 14d, the drive unit 22d and the gearing unit 42d so as to be linearly movable.

FIG. 10 shows the linear mounting unit 142d which includes a guide element 144d which is arranged in the basic body unit 40d. The guide element 144d is realized as a guide rail and/or as a guide rod. In addition, the guide element 144d is fixed by means of fastening elements (not shown here in any detail) of the basic body unit 40d in the basic body unit 40d. In addition, the linear bearing unit 142d includes bearing elements 146d, 148d, which connect a housing 150d of the linear bearing unit 142d to the guide element 144d so as to be linearly movable. The housing 150d is provided for the purpose of receiving the power tool separating device 14d, the drive unit 22d and the gearing unit 42d. A bar-shaped actuating element 152d, which, proceeding from the housing 150d of the linear bearing unit 142d arranged in the basic body unit 40d, extends by way of one end out of the basic body unit 40d, is fastened on the housing 150d. A switching element 154d, which is provided for the purpose of opening and/or closing a circuit for supplying the drive unit 22d with power, is arranged on the end of the actuating element 152d extending out of the basic body unit 40d.

An operator can move the power tool separating device 14d together with the drive unit 22d and the gearing unit 40d in a linear manner along the guide element 144d by means of a linear movement along the direction of the actuating element 152d which extends at least substantially parallel to the support surface 20d. The recess 56d of the support surface 20d, in this connection, is realized in a slot-shaped manner to make it possible for a power tool separating device 14d to extend through the workpiece support unit 12d. At least substantially along 80% of the overall extension of the support surface 20d, the slot-shaped recess 56d extends along a direction of movement of the power tool separating device 14d which runs parallel to the support surface 20d in comparison with an overall extension of the support surface 20d along the direction of movement which runs parallel to the support surface 20d.

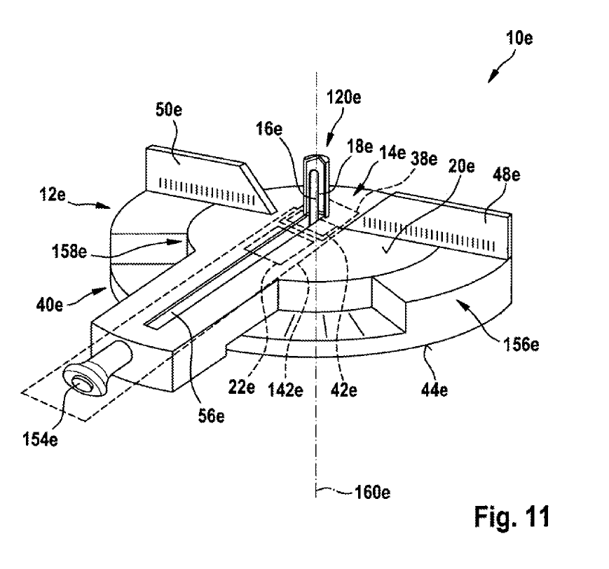

FIG. 11 shows a further alternative power tool system which includes a power tool 10e which is realized as an under floor saw and a power tool separating device 14e. The power tool separating device 14e has a cutting strand 16e and a guide unit 18e for guiding the cutting strand 16e. In addition, the power tool separating device 14e is designed in an analogous manner to the power tool separating device 14a which has been described in FIGS. 1 to 6. The power tool 10e includes a workpiece support unit 12e for supporting a workpiece during processing and a basic body unit 40e on which the workpiece support unit 12e is arranged. The workpiece support unit 12e, in a support surface 20e of the workpiece support unit 12e, has a recess 56e, by means of which the power tool separating device 14e extends in at least one operating state through the workpiece support unit 12e. The power tool separating device 14e, when mounted, is mounted so as to be movable in relation to the workpiece support unit 12e. In this connection, the guide unit 18e, together with the cutting strand 16e mounted on the guide unit 18e, when mounted, is mounted so as to be movable in relation to the workpiece support unit 12e. The power tool separating device 14e is mounted together with a drive unit 22e and a gearing unit 42e of the power tool 10e so as to be linearly movable along a direction extending at least substantially parallel to the support surface 20e in relation to the workpiece support unit 12e. In this connection, the power tool 10e has a linear bearing unit (not shown her in any detail) which is provided for mounting the power tool separating device 14e, the drive unit 22e and the gearing unit 42e so as to be linearly movable. The linear bearing unit, in this connection, is designed in an analogous manner to the linear bearing unit 142d described in FIG. 10. The linear bearing unit of the power tool 10e is arranged in the workpiece support unit 12e.

A part region 156e of the workpiece support unit 12e is realized integrally with the basic body unit 40e. The part region 156e of the workpiece support unit 12e realized integrally with the basic body unit 40e includes two stop elements 48e, 50e which are connected fixedly to the part region 156e realized integrally with basic body unit 40e. However, it is also conceivable for the stop elements 48e, 50e to be connected adjustably to the part region 156e realized integrally with the basic body unit 40e. A further part region 158e of the workpiece support unit 12e, in which the linear bearing unit is arranged and through which the power tool separating device 14e extends, is mounted so as to be pivotable in relation to the basic body unit 40e in the basic body unit 40e. Consequently, the power tool separating device 14e is mounted together with the drive unit 22e and the gearing unit 42e so as to be pivotable in relation to the part region 156e of the workpiece support unit 12e which is realized integrally with the basic body unit 40e. A pivot axis 160e, about which the further part region 158e is mounted so as to be pivotable in the basic body 40e, extends at least substantially at right angles to the support surface 20e of the workpiece support unit 12e. Consequently, the power tool separating device 14e is mounted together with the drive unit 22e and the gearing unit 42e so as to be pivotable about the pivot axis 160e in relation to the part region 156e of the workpiece support unit 12e which is realized integrally with the basic body unit 40e. The further part region 158e of the workpiece support unit 12e, in this connection, is mounted so as to be pivotable about the pivot axis 160e in total by angle of 90° in relation to the basic body unit 40e. The power tool separating device 14e, proceeding from a center position in which the cutting plane is arranged at least substantially at right angles to a stop plane of the stop elements 48e, 50e, can consequently be pivoted into two oppositely directed directions in each case by an angle of 45° in relation to the part region 156e of the workpiece support unit which is realized integrally with the basic body unit 40e. However, it is also conceivable for the power tool separating device 14e to be mounted so as to be pivotable about the pivot axis 160e by another maximum angle.

1. A power tool system having comprising:
at least one power tool having at least one workpiece support unit configured to support a workpiece during processing; and
at least one power tool separating device configured to extend through the at least one workpiece support unit in at least one operating state,
wherein the at least one power tool separating device includes at least one cutting strand and at least one guide unit configured to guide the cutting strand.

2. The power tool system as claimed in claim 1, wherein, when mounted, the at least one power tool separating device is movable at least in relation to the at least one workpiece support unit.

3. The power tool system as claimed in claim 2, wherein, when mounted, the at least one power tool separating device is movable at least substantially at right angles to a support surface of the at least one workpiece support unit.

4. The power tool system at least as claimed in claim 2, wherein, when mounted, the at least one power tool separating device is movable at least substantially parallel to a support surface of the at least one workpiece support unit.

5. The power tool system at least as claimed in claim 2, wherein, when mounted, the at least one power tool separating device and the at least one workpiece support unit are pivotable in relation to one another.

6. The power tool system as claimed in claim 5, wherein the at least one power tool includes at least one drive unit which, when mounted, together with the power tool separating device, is pivotable at least in relation to the workpiece support unit.

7. A power tool separating device for a power tool system having at least one power tool with at least one workpiece support unit configured to support a workpiece during processing, comprising:
at least one cutting strand; and
at least one guide unit configured to guide the cutting strand.

8. The power tool separating device as claimed in claim 7, further comprising:
a torque transmitting element mounted at least in part in the at least one guide unit.

9. The power tool separating device as claimed in claim 8, wherein the at least one cutting strand includes at least one cutting edge carrying element having, on a side facing the torque transmitting element at least one recess into which the torque transmitting element engages to drive the cutting strand in at least one operating state.

10. A power tool for a power tool system comprising:
at least one workpiece support unit configured to support a workpiece during processing; and
at least one coupling device configured to couple the power tool with a power tool separating device having at least one cutting strand and at least one guide unit configured to guide the cutting strand.
